(19) United States
(12) Patent Application Publication
(10) Pub. No.: US 2026/0257513 A1
(43) Pub. Date: Sep. 3, 2026

(54) Production Method For Decorative Article and Treatment Liquid

(71) Applicant: SEIKO EPSON CORPORATION, Tokyo (JP)

(72) Inventors: Kazuki SHIMURA, Yamagata (JP); Toshiaki OGUCHI, Okaya (JP)

(21) Appl. No.: 19/378,408

(22) Filed: Nov. 4, 2025

(30) Foreign Application Priority Data
Nov. 5, 2024 (JP) 2024-193459

(51) Int. Cl. B44C 3/02; C09D 11/104; C09D 11/30; C09D 11/54

(52) U.S. Cl. CPC B44C 3/02; C09D 11/104; C09D 11/30; C09D 11/54

(57) ABSTRACT

Provided is a production method for a decorative article, the production method including a treatment liquid applying step of applying a treatment liquid to a surface having a three-dimensional shape of a base material, an ink composition attaching step of attaching an ink composition containing a sublimable coloring material to an intermediate recording medium by an ink jet method, and a coloring material attaching step of pressure-bonding the intermediate recording medium to the surface of the base material to obtain a laminated body, and heating the laminated body to sublimate the sublimable coloring material and to attach the sublimable coloring material to the surface of the base material. The surface of the base material has hydroxy groups. The treatment liquid contains a crosslinking agent, water, and a resin having an aromatic ring and having a glass transition temperature of 20° C. or higher.

The present application is based on, and claims priority from JP Application Serial Number 2024-193459, filed Nov. 5, 2024, the disclosure of which is hereby incorporated by reference herein in its entirety.

### BACKGROUND

### 1. Technical Field

The present disclosure relates to a production method for a decorative article and a treatment liquid.

### 2. Related Art

There are various kinds of recording media on which images or the like are recorded, such as paper, fabric, and wood, and a suitable printing method varies depending on the kind of recording media. Therefore, various printing methods have been developed in accordance with the kind of recording media. For example, JP-A-2-014199 discloses a mat decorating method for dyeing a mat surface with a design by using sublimation transfer printing in which dyes are sublimated and attached to recording media.

Sublimation transfer printing can be performed on various recording media with a low-cost and simple apparatus. On the other hand, it has been found that decorative articles obtained by sublimation transfer printing have room for improvement in abrasion resistance and color developing properties.

### SUMMARY

The present disclosure is a production method for a decorative article, the production method including a treatment liquid applying step of applying a treatment liquid to a surface having a three-dimensional shape of a base material, an ink composition attaching step of attaching an ink composition containing a sublimable coloring material to an intermediate recording medium by an ink jet method, and a coloring material attaching step of pressure-bonding the intermediate recording medium to the surface of the base material to obtain a laminated body, and heating the laminated body to sublimate the sublimable coloring material and to attach the sublimable coloring material to the surface of the base material, wherein the surface of the base material has hydroxy groups, and the treatment liquid contains a crosslinking agent, water, and a resin having an aromatic ring and having a glass transition temperature of 20° C. or higher.

The present disclosure is a treatment liquid to be applied to a surface having a three-dimensional shape of a base material, the treatment liquid containing a crosslinking agent, water, and a resin having an aromatic ring and having a glass transition temperature of 20° C. or higher.

### BRIEF DESCRIPTION OF THE DRAWINGS

FIG. 1 is a schematic diagram of a recording apparatus for use in the present embodiment.

FIG. 2 is a table showing the results of Examples.

### DESCRIPTION OF EMBODIMENTS

Hereinafter, an embodiment of the present disclosure (hereinafter, referred to as “the present embodiment”) will be described in detail, but the present disclosure is not limited thereto, and various modifications can be made without departing from the gist thereof.

### 1. Production Method for Decorative Article

The production method for a decorative article of the present embodiment includes a treatment liquid applying step of applying a treatment liquid to a surface having a three-dimensional shape of a base material, an ink composition attaching step of attaching an ink composition containing a sublimable coloring material to an intermediate recording medium by an ink jet method, and a coloring material attaching step of pressure-bonding the intermediate recording medium to the surface of the base material to obtain a laminated body, and heating the laminated body to sublimate the sublimable coloring material and to attach the sublimable coloring material to the surface of the base material, wherein the surface of the base material has hydroxy groups, and the treatment liquid contains a crosslinking agent, water, and a resin having an aromatic ring and having a glass transition temperature of 20° C. or higher.

In the recording method in which the sublimable coloring material attached to the intermediate recording medium is sublimated to attach the coloring material to the base material (hereinafter, also referred to as “sublimation transfer recording method”), the base material preferably has a resin layer for receiving the coloring material so that the sublimable coloring material can be favorably attached to the base material. Therefore, the surface of the base material for use in the sublimation transfer recording method generally has a resin layer provided by a surface treatment or has a resin layer from the beginning. Further, even in the case of using a base material the surface of which originally has a resin layer, a resin layer may be newly provided on the surface of the base material by a surface treatment in order to further improve the fixability of the sublimable coloring material. On the other hand, when the surface of the base material is not planar, for example, when the surface of the base material has irregularities or greatly curved, that is, when the surface of the base material has a three-dimensional shape, even if the surface treatment is performed, it is difficult to form the resin layer, or even if the resin layer is formed, unevenness occurs in the thickness of the layer.

In this regard, the treatment liquid for use in the treatment liquid applying step of the present embodiment contains a crosslinking agent and a resin, and the resin has an aromatic ring and a glass transition temperature of 20° C. or higher. Further, the surface of the base material of the present embodiment has hydroxy groups. Thus, even when the surface of the base material has a three-dimensional shape, a uniform resin layer tends to be formed by applying the treatment liquid of the present embodiment to the surface. As a result, the sublimable coloring material attached to the resin layer tends to be less likely to be detached from the base material. That is, the abrasion resistance of a decorative article tends to be improved.

When the glass transition temperature of the resin is 20° C. or higher, the thermal motion of a polymer in the resin is reduced around room temperature (25° C.), which is a general use temperature of the decorative article. Therefore, the sublimable coloring material attached to the resin layer containing such a resin is likely to be firmly held in the resin layer. In addition, the resin layer containing the above resin tends to be hard around room temperature. Furthermore, when the treatment liquid contains a crosslinking agent, the polymer in the resin is crosslinked, and the movement of the resin is further reduced. Therefore, the sublimable coloring material is likely to be more firmly held in the resin layer. Further, the polymer in the resin interacts with the hydroxy groups on the surface of the base material through the crosslinking agent, thereby making the resin layer containing the sublimable coloring material likely to be firmly bonded to the base material. Therefore, it is presumed that the abrasion resistance of the decorative article is improved.

In addition, when the glass transition temperature of the resin is 20° C. or higher, the sublimable coloring material is firmly held in the resin layer, and thus the color developing properties and the discoloration and fading resistance of the decorative article tend to be improved. In addition, when the treatment liquid contains a crosslinking agent, the sublimable coloring material is more firmly held in the resin layer, and the resin layer containing the sublimable coloring material is firmly bonded to the base material. Therefore, the color developing properties and the discoloration and fading resistance of the decorative article tend to be improved.

In addition, when the resin has an aromatic ring, the interaction between the resin and the sublimable coloring material increases, the sublimable coloring material is more easily held in the resin layer, and the abrasion resistance, the color developing properties, and the discoloration and fading resistance of the decorative article tend to be improved. When the sublimable coloring material has an aromatic ring, the aromatic ring of the sublimable coloring material causes a π-π interaction with the aromatic ring of the resin, thereby making the sublimable coloring material more likely to be held in the resin, and the abrasion resistance, the color developing properties, and the discoloration and fading resistance of the decorative article tend to be further improved.

Hereinafter, each step that can be included in the production method for a decorative article of the present embodiment will be described in detail.

### 1.1. Treatment Liquid Applying Step

In the treatment liquid applying step of the present embodiment, a treatment liquid is applied to a surface having a three-dimensional shape of a base material. The application method is not particularly limited, and examples thereof include a method of jetting (jet coating) or spraying (spray coating) the treatment liquid toward the surface of the substrate, a method of applying the treatment liquid to the surface of the base material using a brush or blade, a method of rotating the base material while dropping the treatment liquid on the surface of the base material to spread the treatment liquid on the entire surface of the base material using its centrifugal force (spin coating), and a method of immersing the base material in a bath of the treatment liquid (dip coating).

After the treatment liquid is applied, drying may be accelerated by heating. The heating method is not particularly limited, and for example, a heater may be used, or hot air may be used.

### 1.1.1. Base Material

The surface of the substrate has hydroxy groups. The surface of the base material may originally have hydroxy groups or may be provided with hydroxy groups later. For example, wood, bamboo, and tatami originally have plant-derived hydroxy groups on their surfaces. The method for imparting hydroxy groups to the surface of the base material is not particularly limited, and examples thereof include a method of subjecting the surface of the base material to a plasma treatment.

The surface of the base material has a three-dimensional shape. Here, the three-dimensional shape means irregularities on the surface of tatami, irregularities derived from bamboo nodes on the surface of bamboo, the surface shape of wood processed to have a curved surface, and the like, and does not mean micro irregularities such as the surface of nonwoven fabric or the surface of plain paper. From this viewpoint, a maximum height Pz of the cross-sectional curve of the base material of the present embodiment is 1 mm or more. Note that the maximum height Pz of the cross-sectional curve is a value measured in accordance with JIS B0601: 2013.

The base material of the present embodiment is not particularly limited, and examples thereof include wood, bamboo, tatami, metal, stone, and concrete. Among these, the base material is preferably one or more selected from the group consisting of wood, bamboo, and tatami.

The thickness of the base material of the present embodiment is preferably 0.5 cm or more, 1 cm or more, or 2 cm or more. Alternatively, the thickness of the base material of the present embodiment is preferably 0.5 to 4.0 cm, 1.0 to 3.5 cm, or 2.0 to 3.0 cm.

In addition, the base material of the present embodiment preferably has rigidity. In general, when a decorative article is obtained by performing printing on a base material by a sublimation transfer method, the texture of the decorative article tends to be harder than the texture of the base material. In this regard, when a decorative article is obtained by performing printing on a soft base material such as paper or fabric by the sublimation transfer method, printing that does not impair the soft texture of the base material itself is required in some cases. On the other hand, when a decorative article is obtained by performing printing on a base material having rigidity by the sublimation transfer method, since the base material itself has rigidity and a hard texture, the texture of the decorative article tends not to be significantly changed from that of the base material before printing.

In this regard, since the treatment liquid of the present embodiment contains a resin having a glass transition temperature of 20° C. or higher, the texture of the decorative article obtained by using such a treatment liquid tends to be hard. However, since the base material has rigidity, the influence of the treatment liquid on the texture tends to be reduced.

The base material having rigidity is not particularly limited, and examples thereof include wood, bamboo, tatami, plastic, metal, stone, and concrete. Among these, wood, bamboo, and tatami are preferable as the base material.

The Young's modulus of the base material having rigidity is not particularly limited, and is, for example, 5.0 GPa or more. Although not particularly limited, the Young's modulus is measured by, for example, a Tensilon universal testing machine (manufactured by A&D Company, Limited, trade name: RTG-1250).

Note that the base material of the present embodiment preferably does not include cloth such as fabric and nonwoven fabric, and paper such as plain paper and glossy paper.

### 1.1.2. Treatment Liquid

The treatment liquid of the present embodiment is applied to a surface having a three-dimensional shape of a base material, and contains a crosslinking agent, water, and a resin having an aromatic ring and a glass transition temperature of 20° C. or higher. Hereinafter, each component that can be contained in the treatment liquid will be described in detail.

### 1.1.2.1. Crosslinking Agent

The crosslinking agent includes a crosslinking agent that initiates a crosslinking reaction at room temperature and a crosslinking agent that initiates a crosslinking reaction by heating. Examples of the crosslinking agent include a crosslinking agent having a self-crosslinking property, a compound having a plurality of functional groups that react with an unsaturated carboxylic acid component in the molecule, and a metal having a polyvalent coordination site. One kind of the crosslinking agent may be used alone, or two or more kinds thereof may be used in combination.

The crosslinking agent is preferably an isocyanate compound having an isocyanate group or an oxazoline compound having an oxazoline group from the viewpoint of further improving the abrasion resistance, the color developing properties, and the discoloration and fading resistance of the decorative article.

Examples of the isocyanate compound include a water-dispersible (blocked) polyisocyanate. Note that the (blocked) polyisocyanate means a polyisocyanate and/or a blocked polyisocyanate.

Examples of the water-dispersible polyisocyanate include products obtained by dispersing a polyisocyanate that is imparted with hydrophilicity by a polyethylene oxide chain, in water with an anionic dispersant or a nonionic dispersant.

Examples of the polyisocyanate include diisocyanates such as hexamethylene diisocyanate and isophorone diisocyanate; and derivatives (modified products) of polyisocyanates, such as trimethylolpropane adducts, biurets, and isocyanurates of these diisocyanates.

The water-dispersible blocked polyisocyanate is obtained by blocking an isocyanate group of a water-dispersible polyisocyanate with a blocking agent. Examples of the blocking agent include diethyl malonate, ethyl acetoacetate, ε-caprolactam, butanone oxime, cyclohexanone oxime, 1,2,4-triazole, dimethyl-1,2,4-triazole, 3,5-dimethylpyrazole, and imidazole.

As such an isocyanate compound, a commercially available product may be used. Examples of the commercially available product include Fixer #100ECO, #104EA, #220, 70ECO, #70, #410, and #400 (trade names, manufactured by Murayama Chemical Laboratory Co., Ltd.); and Elastron (registered trademark) BN-11, BN-27, BN-69, and BN-77 (trade names, manufactured by DKS Co. Ltd.)

Examples of the oxazoline compound include a compound having two or more oxazoline groups in the molecule. Examples of such an oxazoline group-containing compound include 2,2′-bis(2-oxazoline), 2,2′-methylene-bis(2-oxazoline), 2,2′-ethylene-bis(2-oxazoline), 2,2′-trimethylene-bis(2-oxazoline), 2,2′-tetramethylene-bis(2-oxazoline), 2,2′-hexamethylene-bis(2-oxazoline), 2,2′-octamethylene-bis(2-oxazoline), 2,2′-ethylene-bis(4,4′-dimethyl-2-oxazoline), 2,2′-p-phenylene-bis(2-oxazoline), 2,2′-m-phenylene-bis(2-oxazoline), 2,2′-m-phenylene-bis(4,4′-dimethyl-2-oxazoline), bis(2-oxazolinylcyclohexane) sulfide, bis(2-oxazolinylnorbornane) sulfide, and an oxazoline ring-containing polymer.

As the oxazoline compound, a commercially available product may be used. Examples of the commercially available product include Epocros (registered trademark) K-2010, K-2020, K-2030, K-2035E, WS-300, WS-500, and WS-700 (trade names manufactured by Nippon Shokubai Co., Ltd.).

The content of the crosslinking agent is preferably 0.1 to 5.0% by mass, 0.5 to 4.5% by mass, or 1.0 to 3.0% by mass with respect to the total amount of the treatment liquid. When the content of the crosslinking agent is within the above range, the abrasion resistance, the color developing properties, and the discoloration and fading resistance of the decorative article tend to be further improved.

### 1.1.2.2. Resin

The glass transition temperature of the resin of the present embodiment is 20° C. or more. The glass transition temperature of the resin is preferably 40° C. or higher, 60° C. or higher, or 80° C. or higher. Alternatively, the glass transition temperature of the resin is preferably 20 to 190° C., 40 to 180° C., 60 to 170° C., or 80 to 160° C. When the glass transition temperature is within the above range, the abrasion resistance, the color developing properties, and the discoloration and fading resistance of the decorative article tend to be further improved. In addition, when the glass transition temperature is the upper limit of the above range or lower, the treatment liquid tends to be easily applied to the surface having a three-dimensional shape of the base material.

The glass transition temperature of the resin can be adjusted by, for example, adjusting the magnitude of the intermolecular interaction between the polymers. For example, when the intermolecular interaction between the polymers increases, the glass transition temperature of the resin tends to become higher. The method for increasing the intermolecular interaction between the polymers is not particularly limited, and examples thereof include a method of increasing the weight average molecular weight of the polymer and a method of introducing a polar group such as a hydroxy group into the polymer to form hydrogen bonds between the polymers.

Note that the weight-average molecular weight can be measured by, for example, gel permeation chromatography (GPC) in terms of polystyrene. The glass transition temperature of the resin can be measured by, for example, a differential scanning calorimeter (DSC).

Further, the resin of the present embodiment has an aromatic ring. The resin of the present embodiment is preferably a polyester resin having an aromatic ring and having a glass transition temperature of 20° C. or higher, an acrylic-styrene resin having an aromatic ring and having a glass transition temperature of 20° C. or higher, and a urethane resin having an aromatic ring and having a glass transition temperature of 20° C. or higher, and more preferably a polyester resin having an aromatic ring and having a glass transition temperature of 20° C. or higher. One kind of the resin may be used alone, or two or more kinds thereof may be used in combination.

The polyester resin is obtained by copolymerizing a polyvalent carboxylic acid and a polyhydric alcohol. The polyester resin has a constituent unit derived from the polyvalent carboxylic acid and a constituent unit derived from the polyhydric alcohol.

The polycarboxylic acid is not particularly limited, and examples thereof include terephthalic acid, isophthalic acid, orthophthalic acid, phthalic acid, 4,4′-diphenyldicarboxylic acid, 2,5-naphthalenedicarboxylic acid, 1,5-naphthalenedicarboxylic acid, 2,6-naphthalenedicarboxylic acid, 2,7-naphthalenedicarboxylic acid, 1,4-cyclohexanedicarboxylic acid, potassium 2-sulfoterephthalate, sodium 5-sulfoisophthalate, adipic acid, azelaic acid, sebacic acid, dodecanedicarboxylic acid, glutaric acid, succinic acid, trimellitic acid, trimesic acid, pyromellitic acid, trimellitic anhydride, phthalic anhydride, succinic anhydride, p-hydroxybenzoic acid, and salts thereof. Examples of the salt include a potassium salt, a sodium salt, a calcium salt, and a magnesium salt. One kind of the polyvalent carboxylic acid may be used alone, or two or more kinds thereof may be used in combination.

The polyhydric alcohol is not particularly limited, and examples thereof include ethylene glycol, 1,2-propylene glycol, 1,3-propylene glycol, 1,3-propanediol, 1,3-butylene glycol, 1,4-butanediol, 1,6-hexanediol, 2-methyl-1,5-pentanediol, neopentyl glycol, 1,4-cyclohexanedimethanol, p-xylylene glycol, bisphenol A-ethylene glycol adduct, diethylene glycol, triethylene glycol, polyethylene glycol, polypropylene glycol, polytetramethylene glycol, polytetramethylene oxide glycol, dimethylolpropionic acid, glycerin, trimethylolpropane, sodium dimethylolethylsulfonate, potassium dimethylolethylsulfonate, and potassium dimethylolpropionate. One kind of the polyhydric alcohol may be used alone, or two or more kinds thereof may be used in combination.

At least one of the polyvalent carboxylic acid and the polyhydric alcohol preferably has an aromatic ring.

As the polyester resin having an aromatic ring, a polyester resin produced using the polyvalent carboxylic acid and the polyhydric alcohol may be used, or a commercially available product may be used.

The acrylic-styrene resin is obtained by copolymerizing an acrylate monomer and a styrene compound, and has a constituent unit derived from the acrylate monomer and a constituent unit derived from the styrene compound.

The acrylate monomer is not particularly limited, and examples thereof include methyl (meth)acrylate, ethyl (meth)acrylate, butyl (meth)acrylate, isopropyl (meth)acrylate, isobutyl (meth)acrylate, pentyl (meth)acrylate, isoamyl (meth)acrylate, hexyl (meth)acrylate, 2-ethylhexyl (meth)acrylate, benzyl (meth)acrylate, and phenyl (meth)acrylate. Note that in the present embodiment, “(meth)acrylate” includes acrylate and methacrylate. The acrylate monomer may have an aromatic ring. One kind of the acrylate monomer may be used alone, or two or more kinds thereof may be used in combination.

Examples of the styrene compound include styrene and modified styrene. The modified styrene is a compound in which hydrogen directly bonded to carbon constituting the benzene ring of styrene is replaced with another functional group. The modified styrene is not particularly limited, and examples thereof include chlorostyrene, fluorostyrene, phenylstyrene, methylstyrene, ethylstyrene, and carboxystyrene. One kind of the styrene compound may be used alone, or two or more kinds thereof may be used in combination.

As the acrylic-styrene resin having an aromatic ring, an acrylic-styrene resin produced using the acrylate monomer and the styrene compound may be used, or a commercially available product may be used.

The urethane resin is a resin having a urethane bond. The urethane resin is obtained by, for example, copolymerizing a polyvalent isocyanate and a polyhydric alcohol, and has a constituent unit derived from the polyvalent isocyanate and a constituent unit derived from the polyhydric alcohol.

The polyvalent isocyanate is not particularly limited, and examples thereof include an aliphatic polyvalent isocyanate and an aromatic polyvalent isocyanate. The aliphatic polyvalent isocyanate is not particularly limited, and examples thereof include polyvalent isocyanates having a chain structure such as tetramethylene diisocyanate, dodecamethylene diisocyanate, hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate, and 3-methylpentane-1,5-diisocyanate; and polyvalent isocyanates having a cyclic structure such as isophorone diisocyanate, hydrogenated xylylene diisocyanate, 4,4′-dicyclohexylmethane diisocyanate, 1,4-cyclohexane diisocyanate, methylcyclohexylene diisocyanate, and 1,3-bis(isocyanatomethyl)cyclohexane. One kind of the aliphatic polyvalent isocyanate may be used alone, or two or more kinds thereof may be used in combination.

The aromatic polyvalent isocyanate is not particularly limited, and examples thereof include tolylene diisocyanate, 2,2′-diphenylmethane diisocyanate, 2,4′-diphenylmethane diisocyanate, 4,4′-diphenylmethane diisocyanate, 4,4′-dibenzyl diisocyanate, 1,5-naphthylene diisocyanate, xylylene diisocyanate, 1,3-phenylene diisocyanate, 1,4-phenylene diisocyanate, dialkyldiphenylmethane diisocyanate, tetraalkyldiphenylmethane diisocyanate, and α, α, α′, α′-tetramethylxylylene diisocyanate. One kind of the aromatic polyvalent isocyanate may be used alone, or two or more kinds thereof may be used in combination.

The polyhydric alcohol is not particularly limited, and examples thereof include ethylene glycol, 1,2-propylene glycol, 1,3-propylene glycol, 1,3-propanediol, 1,3-butylene glycol, 1,4-butanediol, 1,6-hexanediol, 2-methyl-1,5-pentanediol, neopentyl glycol, 1,4-cyclohexanedimethanol, p-xylylene glycol, bisphenol A-ethylene glycol adduct, diethylene glycol, triethylene glycol, polyethylene glycol, polypropylene glycol, polytetramethylene glycol, polytetramethylene oxide glycol, dimethylolpropionic acid, glycerin, trimethylolpropane, sodium dimethylolethylsulfonate, potassium dimethylolethylsulfonate, and potassium dimethylolpropionate. One kind of the polyhydric alcohol may be used alone, or two or more kinds thereof may be used in combination.

At least one of the polyvalent isocyanate and the polyhydric alcohol preferably has an aromatic ring.

As the urethane resin having an aromatic ring, a urethane resin produced using the polyvalent isocyanate and the polyhydric alcohol may be used, or a commercially available product may be used.

The content of the resin having an aromatic ring and having a glass transition temperature of 20° C. or higher is preferably 1 to 20% by mass, 3 to 17% by mass, 5 to 15% by mass, or 7 to 13% by mass with respect to the total amount of the treatment liquid. When the content of the resin having an aromatic ring is within the above range, the abrasion resistance, the color developing properties, and the discoloration and fading resistance of the decorative article tend to be further improved.

The content of the polyester resin having an aromatic ring and having a glass transition temperature of 20° C. or higher is preferably 1 to 20% by mass, 3 to 17% by mass, 5 to 15% by mass, or 7 to 13% by mass with respect to the total amount of the treatment liquid. When the content of the polyester resin having an aromatic ring is within the above range, the abrasion resistance, the color developing properties, and the discoloration and fading resistance of the decorative article tend to be further improved.

The content of the polyester resin having an aromatic ring and having a glass transition temperature of 20° C. or higher is preferably 70 to 100% by mass, 80 to 100% by mass, or 90 to 100% by mass with respect to the total amount of the resin having an aromatic ring and having a glass transition temperature of 20° C. or higher. When the content of the polyester resin having an aromatic ring is within the above range, the abrasion resistance, the color developing properties, and the discoloration and fading resistance of the decorative article tend to be further improved.

The content of the acrylic-styrene resin having an aromatic ring and having a glass transition temperature of 20° C. or higher is preferably 1 to 20% by mass, 3 to 17% by mass, 5 to 15% by mass, or 7 to 13% by mass with respect to the total amount of the treatment liquid. When the content of the acrylic-styrene resin having an aromatic ring is within the above range, the abrasion resistance, the color developing properties, and the discoloration and fading resistance of the decorative article tend to be further improved.

The content of the urethane resin having an aromatic ring and having a glass transition temperature of 20° C. or higher is preferably 1 to 20% by mass, 3 to 17% by mass, 5 to 15% by mass, or 7 to 13% by mass with respect to the total amount of the treatment liquid. When the content of the urethane resin having an aromatic ring is within the above range, the abrasion resistance, the color developing properties, and the discoloration and fading resistance of the decorative article tend to be further improved.

The ratio (W_{R}/W_{C}) of a content W_{R} of the resin to a content W_{C} of the crosslinking agent is preferably 2.0 to 10.0, 2.5 to 8.0, or 3.0 to 6.0. When the ratio (W_{R}/W_{C}) is within the above range, the abrasion resistance, the color developing properties, and the discoloration and fading resistance of the decorative article tend to be further improved.

### 1.1.2.3. Water

The treatment liquid of the present embodiment contains water. The water is not particularly limited, and may be, for example, pure water or ion exchanged water. The content of the water is preferably 60% by mass or more, 60 to 95% by mass, 65 to 90% by mass, or 70 to 90% by mass with respect to the total amount of the treatment liquid. When the content of the water is within the above range, the abrasion resistance, the color developing properties, and the discoloration and fading resistance of the decorative article tend to be further improved.

### 1.1.2.4. Other Additives

The treatment liquid of the present embodiment may contain other additives other than the above-described components. The other additives are not particularly limited, and examples thereof include an ultraviolet absorber, a surfactant, a dissolution aid, a viscosity modifier, a humectant, a PH adjuster, an antioxidant, a preservative; a fungicide, a corrosion inhibitor, and a chelating agent. The content of the other additives is not particularly limited, and is, for example, 0.1 to 5.0% by mass with respect to the total amount of the treatment liquid.

### 1.1.3. Production Method for Treatment Liquid

The treatment liquid can be prepared by mixing the components in any order, and removing impurities, foreign substances, and the like by performing filtration or the like as necessary. As a method of mixing the components, a method of sequentially adding the components to a container equipped with a stirrer such as a mechanical stirrer or a magnetic stirrer, and stirring and mixing them is used. Examples of the filtration method include centrifugal filtration and filter filtration.

### 1.2. Ink Composition Applying Step

In the ink composition applying step, an ink composition containing a sublimable coloring material is applied to an intermediate recording medium by an ink jet method.

In the ink jet method, the ink composition is ejected from an ink jet head. Examples of the ink jet head include a piezo type ink jet head using a piezoelectric element the volume of which changes when a voltage is applied, and a thermal type ink jet head that generates bubbles in the ink by heating to eject the ink, and the piezo type ink jet head is preferable.

Examples of the ink jet head include a line head that performs recording by a line method and a serial head that performs recording by a serial method.

In the line method using the line head, for example, an ink jet head having a width equal to or larger than the recording width of the intermediate recording medium is fixed to a recording apparatus. Then, an image is recorded on the intermediate recording medium by moving the intermediate recording medium along a sub-scanning direction (the transport direction of the intermediate recording medium), and ejecting ink droplets from the nozzles of the ink jet head in conjunction with this movement.

In the serial method using the serial head, for example, an ink jet head is mounted on a carriage that can move in the width direction of the intermediate recording medium. Then, an image is recorded on the intermediate recording medium by moving the carriage along a main scanning direction (the width direction of the intermediate recording medium), and ejecting ink droplets from the nozzles of the ink jet head in conjunction with this movement.

### 1.2.1. Ink Composition

The ink composition to be applied to the intermediate recording medium by the ink jet method contains a sublimable coloring material, and may contain a solvent and other additives. Hereinafter, each component that can be contained in the ink composition will be described in detail.

### 1.2.1.1. Sublimable Coloring Material

The sublimable coloring material of the present embodiment is a coloring material that is sublimated by heating, and is, for example, a sublimable dye that is sublimated by heating. The sublimation temperature is not particularly limited, and is, for example, 120° C. or higher, 140° C. or higher, or 160° C. or higher. The upper limit of the sublimation temperature is not particularly limited, and is, for example, 220° C. or lower, and preferably 200° C. or lower. The sublimable coloring material preferably has an aromatic ring. The sublimable dye is not particularly limited, and examples thereof include dispersed dyes such as C.I. Disperse Yellow 3, 7, 8, 23, 39, 51, 54, 60, 64, 71, 82, 86, 211, and 232, C.I. Disperse Orange 1, 1:1, 5, 20, 24, 25, 25:1, 33, 56, and 76, C.I. Disperse Brown 2 and 27, C.I. Disperse Red 11, 50, 53, 55, 55:1, 59, 60, 65, 70, 75, 93, 146, 158, 190, 190:1, 207, 239, 240, and 364, C.I. Disperse Violet 8, 17, 23, 27, 28, 29, 36, and 57, C.I. Disperse Blue 14, 19, 26, 26:1, 35, 55, 56, 58, 64, 64:1, 72, 72:1, 81, 81:1, 91, 95, 108, 131, 141, 145, 359, and 360; and solvent dyes such as C.I. Solvent Blue 36, 63, 94, 105, and 111. Note that the dispersed dye is a dye that is dispersed in water by a dispersant. The solvent dye is a dye soluble in an organic solvent such as ethanol or acetone.

The content of the sublimable coloring material is not particularly limited, and is, for example, 0.5 to 20.0% by mass, or 1.0 to 15.0% by mass with respect to the total amount of the ink composition.

### 1.2.1.2. Solvent

The ink composition of the present embodiment preferably contains a solvent. Examples of the solvent include water; aprotic polar solvents such as pyrrolidones such as 2-pyrrolidone, imidazolidinones, sulfoxides, lactones, amide ethers, and imidazoles; monoalcohols such as methanol and ethanol; alkyl polyols such as glycerin, ethylene glycol, diethylene glycol, triethylene glycol, and alkanediols; and alkyl ethers of polyhydric alcohols such as dialkyl ethers of polyhydric alcohols and monoalkyl ethers of polyhydric alcohols; among these, water is preferable.

The content of the solvent is not particularly limited, and is, for example, 50 to 90% by mass with respect to the total amount of the ink composition.

### 1.2.1.3. Other Additives

The ink composition of the present embodiment may contain other additives other than the above-described components. The other additives are not particularly limited, and examples thereof include a dispersant, a surfactant, a dissolution aid, a viscosity modifier, a humectant, a pH adjuster, an antioxidant, a preservative, a fungicide, a corrosion inhibitor, and a chelating agent.

The content of the other additives is not particularly limited, and is, for example, 0.1 to 10.0% by mass with respect to the total amount of the ink composition.

### 1.2.2. Production Method for Ink Composition

The ink composition can be prepared by mixing the components in any order, and removing impurities, foreign substances, and the like by filtration or the like as necessary. As a method of mixing the components, a method of sequentially adding the components to a container equipped with a stirrer such as a mechanical stirrer or a magnetic stirrer, and stirring and mixing them is used. Examples of the filtration method include centrifugal filtration and filter filtration.

### 1.2.3. Intermediate Recording Medium

The intermediate recording medium to which the ink composition is applied is not particularly limited so long as it is a recording medium on which the sublimable coloring material contained in the attached ink composition can be sublimated, and examples thereof include transfer paper. Specific examples of the transfer paper include DS Transfer Multi Purpose (manufactured by Seiko Epson Corporation).

### 1.3. Coloring Material Attaching Step

In the coloring material attaching step, the intermediate recording medium is pressure-bonded to the surface of the base material to obtain a laminated body, and the laminated body is heated to sublimate the sublimable coloring material and to attach the sublimable coloring material to the surface of the base material. The coloring material attaching step is performed after the treatment liquid applying step, and the surface of the base material to which the coloring material is attached in the coloring material attaching step is the surface to which the treatment liquid has been applied. A resin layer is preferably formed on the surface of the base material to which the coloring material is attached in the coloring material attaching step.

The heating of the laminated body may be performed after the laminated body is obtained, or may be performed at the same time as the recording surface of the intermediate recording medium and the base material are superimposed on each other. The temperature at which the laminated body is heated is preferably 155 to 215° C., or 160 to 210° C.

When the laminated body is heated, application of pressure may be performed simultaneously with the heating. For example, by using a heat press machine, heating and application of pressure can be performed simultaneously. Alternatively, the laminated body may be heated after pressure is applied to the laminated body in advance. For example, after the laminated body is wrapped with a heat-resistant wrap and pressure is applied thereto, the laminated body wrapped with the heat-resistant wrap may be put into an oven and heated.

### 1.4. Protective Layer Forming Step

The production method for a decorative article of the present embodiment may include a protective layer forming step of providing a protective layer on the surface of the base material to which the sublimable coloring material has been attached, after the coloring material attaching step. When the protective layer is provided, the abrasion resistance, the color developing properties, and the discoloration and fading resistance of the decorative article tend to be further improved. The material of the protective layer is not particularly limited, and examples thereof include a urethane resin, an acrylic resin, an epoxy resin, a silicone resin, and a fluororesin.

On the other hand, since the decorative article produced by the production method for a decorative article of the present embodiment tends to be excellent in the abrasion resistance, the color developing properties, and the discoloration and fading resistance even when the protective layer is not provided, the production method of the present embodiment may not include the protective layer forming step.

### 2. Ink Jet Recording Apparatus

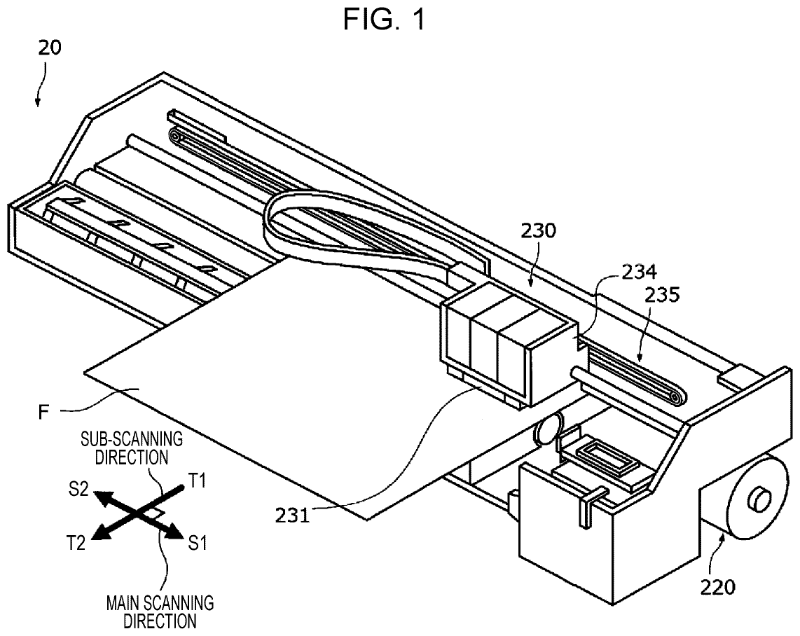

FIG. 1 shows a perspective view of a serial printer as an example of an ink jet apparatus. As shown in FIG. 1, a serial printer 20 includes a transport section 220 and a recording section 230. The transport section 220 transports a recording medium F fed to the serial printer to the recording section 230, and discharges the recording medium after recording to the outside of the serial printer. Specifically, the transport section 220 includes feed rollers, and transports the fed recording medium F in a sub-scanning direction T2.

The recording section 230 includes a carriage 234 on which an ink jet head 231 having nozzles that eject the ink composition onto the recording medium F sent from the transport section 220 is mounted, and a carriage movement mechanism 235 that moves the carriage 234 in main scanning directions S1 and S2 of the recording medium F.

In the case of the serial printer, a head having a length smaller than the width of the recording medium is provided as the ink jet head 231, the head moves, and recording is performed in a plurality of passes (multi-pass). In addition, in the serial printer, the head 231 is mounted on the carriage 234 that moves in a predetermined direction, and the ink composition is ejected onto the recording medium F by the head moving along with the movement of the carriage. As a result, recording is performed in two or more passes (multi-pass). The pass is also referred to as main scanning. Sub-scanning in which the recording medium is transported is performed between the passes. That is, the main scanning and the sub-scanning are alternately performed.

Further, the ink jet apparatus of the present embodiment is not limited to the above serial type printer, and may be the above-described line type printer. The line type printer is a printer that performs recording on a recording medium in one scan using a line head, which is an ink jet head having a length equal to or larger than the recording width of the recording medium.

### EXAMPLES

Hereinafter, the present disclosure will be described in more detail with reference to Examples and Comparative Examples. The present disclosure is not limited by Examples below in any way. Unless otherwise specified, each operation in Examples was performed under an environment of room temperature (25° C.) and 1 atm.

### 1. Preparation of Treatment Liquid

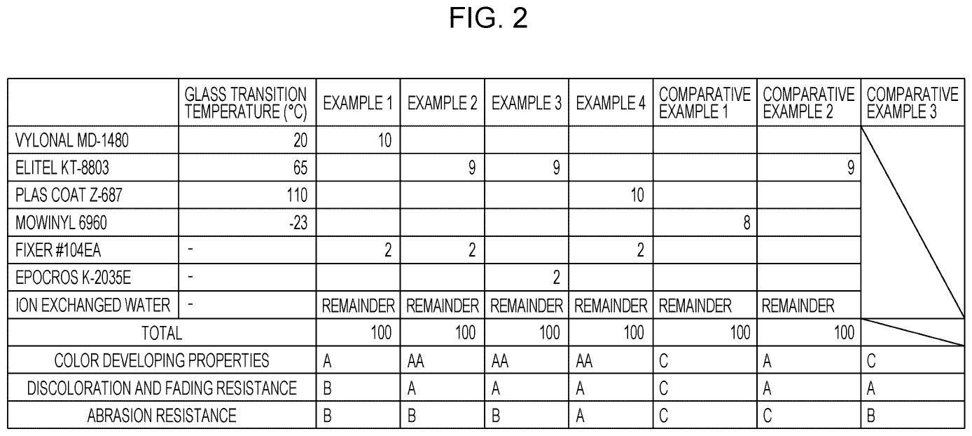

Each component was put into a tank for mixture use, which is a stainless steel container, so as to have the composition described in FIG. 2, mixed and stirred at room temperature, and impurities, foreign substances, and the like were removed by performing filtration or the like as necessary to obtain a treatment liquid used in each example. It is noted that the numerical value of each component shown in each example in the figure represents mass percentage unless otherwise described. In addition, the mass percentage of the resin represents a solid content concentration. The components in the figure show the following:
Vylonal MD-1480: polyester resin having an aromatic ring, manufactured by Toyobo Co., Ltd.
Elitel KT-8803: polyester resin having an aromatic ring, manufactured by Unitika Ltd.
Plas Coat Z-687: polyester resin having an aromatic ring, manufactured by Goo chemical Co., Ltd.
Mowinyl 6960: acrylic-styrene resin, manufactured by Japan Coating Resin Co., Ltd.
Fixer #104EA: crosslinking agent (isocyanate compound) manufactured by Murayama Chemical Laboratory Co., Ltd.
Epocros K-2035E: crosslinking agent (oxazoline compound), manufactured by Nippon Shokubai Co., Ltd.

### 2. Treatment Liquid Applying Step

The treatment liquid of each example was applied to a bamboo screen for steaming basket use using a sponge roller, and then dried in an oven at 150° C. for 3 minutes to obtain a base material to which the treatment liquid was applied.

### 3. Ink Composition Applying Step

Using a printer equipped with a sublimable dye (SC-F9450 (trade name), manufactured by Seiko Epson Corporation), a magenta ink (sublimable ink SC20MP, manufactured by Seiko Epson Corporation) was printed on an intermediate recording medium (DS Transfer Multi Purpose (trade name), manufactured by Seiko Epson Corporation) at 100% duty with resolutions of horizontal 720 dpi and vertical 720 dpi.

Note that “duty” is a value calculated by the following expression, and 100% duty means that one droplet of ink is attached to every pixel.
duty (%)=number of actually printed dots/(vertical resolution×horizontal resolution)×100
where “number of actually printed dots” is the number of actually printed dots per unit area, and “vertical resolution” and “horizontal resolution” are each a resolution per unit area.

### 4. Coloring Material Attaching Step

The surface of the base material to which the treatment liquid had been applied obtained in the treatment liquid applying step and the surface of the intermediate recording medium to which the ink had been applied obtained in the ink composition applying step were superimposed on each other to obtain a laminated body. Then, the laminated body was heated at 180° C. for 60 seconds using a heat press machine (AF 54TEN (trade name), manufactured by Itsumi Co., Ltd.) to sublimate the sublimable dye attached to the intermediate recording medium and to transfer the sublimable dye to the surface of the base material to which the treatment liquid had been applied, thus obtaining a decorative article of each example. Note that the base material in the decorative article of Comparative Example 3 was not subjected to the treatment liquid applying step.

### 5. Evaluation

### 5.1. Color Developing Properties

Using a spectrodensitometer (FD-7 (trade name), manufactured by Konica Minolta, Inc.) and a D₆₅ light source, the optical density (OD value) of the printed surface of the decorative article of each example immediately after the coloring material attaching step was measured under the condition of a viewing angle of 2 degrees, and evaluated based on the following evaluation criteria. The evaluation results are shown in FIG. 2.

### Evaluation Criteria

AA: The OD value is 1.2 or more.
A: The OD value is 1.1 or more and less than 1.2.
B: The OD value is 1.0 or more and less than 1.1.
C: The OD value is less than 1.0.

### 5.2. Discoloration and Fading Resistance

The decorative article of each example was left for 3 days after the coloring material attaching step. Then, using a spectrodensitometer (FD-7 (trade name), manufactured by Konica Minolta, Inc.) and a D₆₅ light source, the OD value of the printed surface of the decorative article of each example left for 3 days was measured under the condition of a viewing angle of 2 degrees.

How much the OD value of the printed surface of the decorative article of each example left for 3 days decreased with respect to the OD value of the printed surface of the decorative article of each example immediately after the coloring material attaching step was calculated, and evaluation was performed based on the following evaluation criteria. The evaluation results are shown in FIG. 2.

### Evaluation Criteria

A: The OD value decrease rate ((OD value immediately after coloring material attaching step-OD value after being left for 3 days)/OD value immediately after coloring material attaching step×100) is less than 2%.
B: The OD value decrease rate is 2% or more and less than 5%.
C: The OD value decrease rate is 5% or more.

### 5.3. Abrasion Resistance (Tape Peeling Properties)

A cellophane tape was attached to the printed surface of the decorative article of each example immediately after the coloring material attaching step, and left for 24 hours. Thereafter, the tape was peeled off, and the presence or absence of the coloring material attached to the peeled tape was visually observed, and evaluated based on the following evaluation criteria. The evaluation results are shown in FIG. 2. Note that it can be said that it has good abrasion resistance in the case of having an evaluation of B or higher.

### Evaluation Criteria

A: No attachment of the coloring material is observed on the peeled tape.
B: Attachment of the coloring material is slightly observed on the peeled tape.
C: Attachment of the coloring material is observed on the peeled tape.

Note that the same evaluation was performed using a 100% by mass treatment liquid obtained by further adding 2% by mass of Fixer #104EA, a crosslinking agent, to the composition of Comparative Example 1 to reduce the mass of the ion exchanged water accordingly. The OD value immediately after the coloring material attaching step was lower than those of Examples.

What is claimed is:

1. A production method for a decorative article, the production method comprising:
a treatment liquid applying step of applying a treatment liquid to a surface having a three-dimensional shape of a base material;
an ink composition attaching step of attaching an ink composition containing a sublimable coloring material to an intermediate recording medium by an ink jet method; and
a coloring material attaching step of pressure-bonding the intermediate recording medium to the surface of the base material to obtain a laminated body, and heating the laminated body to sublimate the sublimable coloring material and to attach the sublimable coloring material to the surface of the base material, wherein
the surface of the base material has hydroxy groups, and
the treatment liquid contains a crosslinking agent, water, and a resin having an aromatic ring and having a glass transition temperature of 20° C. or higher.

2. The production method according to claim 1, wherein the base material includes one or more selected from the group consisting of wood, tatami, and bamboo.

3. The production method according to claim 1, wherein the resin includes one or more selected from the group consisting of a polyester resin, an acrylic-styrene resin, and a urethane resin.

4. The production method according to claim 1, wherein the glass transition temperature of the resin is 60° C. or higher.

5. The production method according to claim 1, wherein a content of the resin is 1 to 20% by mass with respect to a total amount of the treatment liquid.

6. The production method according to claim 1, wherein the crosslinking agent includes an isocyanate compound or an oxazoline compound.

7. The production method according to claim 1, wherein a content of the crosslinking agent is 0.1 to 5.0% by mass with respect to a total amount of the treatment liquid.

8. The production method according to claim 1, wherein a content of the water is 60% by mass or more with respect to a total amount of the treatment liquid.

9. The production method according to claim 1, not comprising a protective layer forming step of providing a protective layer on the surface of the base material to which the sublimable coloring material has been attached after the coloring material attaching step.

10. A treatment liquid to be applied to a surface having a three-dimensional shape of a base material, the treatment liquid comprising:
a crosslinking agent;
water; and
a resin having an aromatic ring and having a glass transition temperature of 20° C. or higher.

11. The treatment liquid according to claim 10, wherein the resin includes one or more selected from the group consisting of a polyester resin, an acrylic-styrene resin, and a urethane resin.

12. The treatment liquid according to claim 10, wherein the glass transition temperature of the resin is 60° C. or higher.

13. The treatment liquid according to claim 10, wherein a content of the resin is 1 to 20% by mass with respect to a total amount of the treatment liquid.

14. The treatment liquid according to claim 10, wherein the crosslinking agent includes an isocyanate compound or an oxazoline compound.

15. The treatment liquid according to claim 10, wherein a content of the crosslinking agent is 0.1 to 5.0% by mass with respect to a total amount of the treatment liquid.

16. The treatment liquid according to claim 10, wherein a content of the water is 60% by mass or more with respect to a total amount of the treatment liquid.
